(19) United States
(12) Patent Application Publication
(10) Pub. No.: US 2015/0100473 A1
(43) Pub. Date: Apr. 9, 2015

(54) CREDIT THROUGH UNSTRUCTURED SUPPLEMENTARY SERVICE DATA

(71) Applicants: Anantha Srinivasan Manoharan, Chennai (IN); Jagadeesh Balasubramaniyan, Chennai (IN); Gajendran Mani, Tamilnadu (IN)

(72) Inventors: Anantha Srinivasan Manoharan, Chennai (IN); Jagadeesh Balasubramaniyan, Chennai (IN); Gajendran Mani, Tamilnadu (IN)

(21) Appl. No.: 14/050,155

(22) Filed: Oct. 9, 2013

(51) Int. Cl. G06Q 40/02; G06Q 20/24

(52) U.S. Cl. CPC G06Q 40/025; G06Q 20/24
USPC 705/38

(57) ABSTRACT

Methods and systems for providing credit through USSD are described. A user dials a short USSD code onto his or her mobile device, and is prompted to enter an authentication code to confirm his or her identity. Once authenticated, the user is presented with a USSD menu that includes an option to pay with credit. The user chooses this option, and is prompted to enter an amount for the credit. The service provider checks the credit score of the user, and approves or denies credit based on the score. When the credit score is acceptable, the user is asked to enter the merchant ID for the store and to confirm checkout. The amount for the purchase is then transferred to the merchant by the service provider.

### BACKGROUND

1. Field of the Invention

The present invention generally relates to financial transactions, and more specifically, to using a mobile device to obtain credit and pay for a purchase.

2. Related Art

Consumers and the general population are utilizing mobile devices, such as smart phones, more than ever before and not just to make and receive calls. The number of users, devices, and device capabilities continue to increase. One of the reasons for this increased use is the ease and/or convenience of performing tasks with a mobile device. These include accessing content, such as through the Internet or Apps, taking and sharing photos, videos, and music, playing games, listening to music, watching videos, shopping, and performing financial transactions, such as sending and receiving money.

Service providers are thus becoming more and more important for these mobile device users. Merchants, retailers, and marketplaces, such as eBay®, Inc. of San Jose, Calif., enable users to shop online through their mobile devices. A payment provider, such as PayPal®, Inc. of San Jose, Calif., allows users to complete an online shopping process by enabling users to send and receive payments through the mobile device. Thus, a user can find an item and make the purchase through the mobile device, and then have the purchased item delivered to the user. One difficulty with mobile device shopping, however, is that an Internet connection typically needs to be established, and therefore a smart phone is usually required.

Thus, it is desirable to provide methods and systems that aid the shopping experience without the need for the Internet.

### BRIEF DESCRIPTION OF THE FIGURES

FIG. 1 is a block diagram illustrating a system for providing credit through Unstructured Supplementary Service Data (USSD) technology according to an embodiment of the present disclosure;

FIGS. 2A-2G illustrate the sequence of USSD screens that are prompted on a mobile device as part of a USSD session according to an embodiment of the present disclosure;

FIG. 3 is a flowchart showing the steps of authenticating a user in a method of providing credit through USSD according to an embodiment of the present disclosure;

FIG. 4 is a flowchart showing the steps after the user is authenticated in a method of providing credit through USSD; and

FIG. 5 is a block diagram of a system for implementing one or more components in FIG. 1 according to an embodiment of the present disclosure.

Embodiments of the present disclosure and their advantages are best understood by referring to the detailed description that follows. In addition, the present disclosure may repeat reference numerals and/or letters in the various examples. This repetition is for the purpose of simplicity and clarity and does not in itself dictate a relationship between the various embodiments and/or configurations discussed.

### DETAILED DESCRIPTION

The present disclosure provides methods and systems that can be used to obtain credit and pay for purchases at a physical store using Unstructured Supplementary Service Data (USSD) services on a mobile device. USSD is a menu-based system that enables interfacing with content based services. Thus, instead of using a mobile web-browser to open and browse a website, which needs an Internet/general packet radio service (GPRS) connection, the USSD service acts as a browser interface to pull content to the mobile device. No Internet connection is needed, and the cost of using this service is reduced. USSD is available on all mobile devices, from the lowest model black/white mobile phones to high end smart phones. USSD has been a boon in developing regions, where it has been used to implement, at very low cost, efficient mobile payment systems for people previously without access to banks or credit cards.

The USSD service is an interactive data service based on a Global System for Mobile Communications (GSM) network. A user can enter a service access code custom-made by a network in advance through a keypad, for example, “*108#,” and then press a “transmit key” or by voice so that an instruction can be transmitted to the network. The network returns a main menu according to the instruction transmitted by the user, the user can select a next operation according to a prompt of the main menu, and the network returns to the next level of menu or content according to the selection of the user, thereby providing the USSD service needed by the user.

For example, a user walks into a physical store and makes a purchase. The user dials a short USSD code (e.g., *123#) dedicated to a service provider on his or her mobile device. The user is then prompted to enter an authentication code (e.g., personal identification number or PIN) to confirm his or her identity with the service provider. Once authenticated, the user is presented with the service provider's USSD menu that includes an option to pay with credit. The user chooses this option, and is prompted to enter an amount for the credit. The service provider checks the credit score of the user, and approves or denies credit based on the score. If the credit score is acceptable, the user is asked to enter the merchant ID for the store and to confirm checkout. The amount for the purchase is then transferred to the merchant by the service provider.

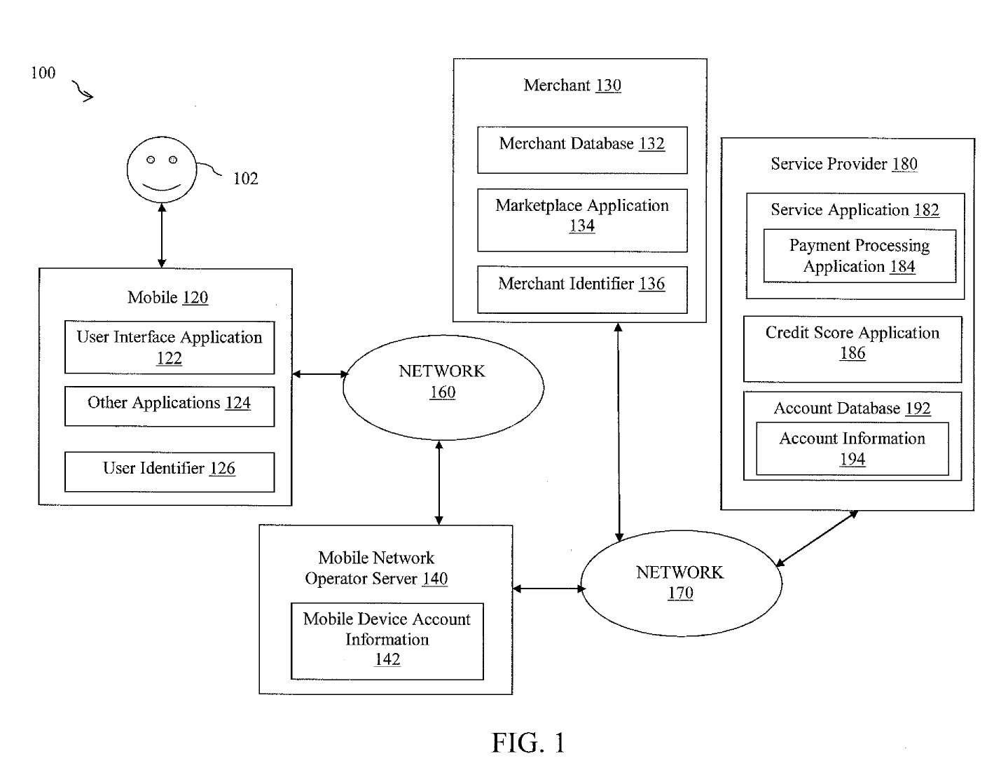

FIG. 1 shows one embodiment of a block diagram of a network-based system 100 adapted to provide credit utilizing USSD technology. The system 100 can be powered by a USSD mechanism that offers a high-speed, session oriented, menu-driven user experience. Many GSM devices support USSD. The USSD mechanism can be hosted by a server or database that maintains the processing session between the user that is making the payment and a payment service provider.

As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a mobile device 120 (e.g., network computing device), merchant device 130, a mobile network operator server 140, and at least one service provider server or device 180 (e.g., network server device) in communication over the networks 160 and 170. In an exemplary embodiment, network 160 is a GSM network, the standard system used by most mobile phone networks around the world.

The networks 160 and/or 170, in one embodiment, may be implemented as a single network or a combination of multiple networks. For example, in various embodiments, the networks 160 and/or 170 may include the Internet and/or one or more intranets, landline networks, wireless networks, and/or other appropriate types of communication networks. In another example, the networks 160 and/or 170 may comprise a wireless telecommunications network (e.g., cellular phone network) adapted to communicate with other communication networks, such as the Internet.

The mobile device 120, in various embodiments, may be implemented using any appropriate combination of hardware and/or software configured for wired and/or wireless communication over the network 160. In various examples, mobile device 120 may be implemented as a wireless telephone (e.g., cellular or mobile phone), a tablet, a personal digital assistant (PDA), a tablet computer, and/or various other generally known types of wired and/or wireless computing devices. It should be appreciated that mobile device 120 may be referred to as a user device or a customer device without departing from the scope of the present disclosure.

The mobile device 120 is configured to communicate USSD messages that include authentication and payment information. This information can be communicated to a service provider server 180 that can issue credit to the user 102 and apply the proper payment to the correct merchant account. The user 102 of the mobile device 120 can initiate a payment transaction by entering a short code that is communicated to the network operator server 140 through wired or wireless means. After initiation of the communication, the user 102 can input authentication and payment information.

The mobile device 120, in one embodiment, includes a user interface application 122, which may be utilized by the user 102 to conduct transactions (e.g., shopping, purchasing, bidding, transferring, etc.) with the service provider server 180 over the network 160. In one aspect, funds may be directly and/or automatically debited from an account related to the user 102 via the user interface application 122 and deposited into an account associated with the merchant 130.

In one implementation, the user interface application 122 comprises a software program, such as a text-based interface, executable by a processor that is configured to interface and communicate with the service provider server 180 via the networks 160 and/or 170. In another implementation, the user interface application 122 comprises a browser module that provides a network interface to browse information available over the networks 160 and/or 170. For example, the user interface application 122 may be implemented, in part, as a web browser to view information available over the networks 160 and/or 170.

The mobile device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the networks 160 and/or 170, and/or various other types of generally known programs and/or software applications. In still other examples, the other applications 124 may interface with the user interface application 122 for improved efficiency and convenience.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., a personal identification number) and banking information and/or funding sources (e.g., one or more banking institutions, credit card issuers, user account numbers, security data and information, etc.). In various implementations, the user identifier 126 may be passed with a user login request to the service provider server 180 via the networks 160 and 170, and the user identifier 126 may be used by the service provider server 180 to associate the user 102 with a particular user account maintained by the service provider server 180.

The merchant device 130, in various embodiments, may be maintained by one or more business entities (or in some cases, by a partner of a business entity that processes transactions on behalf of business entities). Examples of businesses entities include merchant sites, brick-and-mortar stores, resource information sites, utility sites, real estate management sites, social networking sites, etc., which offer various items for purchase and payment. In some embodiments, business entities may need registration of the user identity information as part of offering the items to the user 102. As such, the merchant device 130 may include a merchant database 132 for identifying available items, which may be made available to the mobile device 120 for viewing and purchase by the user 102. In one or more embodiments, user 102 may complete a transaction such as purchasing the items via service provider server 180.

The merchant device 130, in one embodiment, may include a marketplace application 134, which may be configured to provide information over the networks 160 and 170 to the user interface application 122 of mobile device 120. For example, user 102 may interact with the marketplace application 134 through the user interface application 122 over the networks 160 and 170 to search and view various items available for purchase in the merchant database 132.

The merchant device 130, in one embodiment, may include at least one merchant identifier 136, which may be included as part of the one or more items made available for purchase so that, e.g., particular items are associated with particular merchants. In one implementation, the merchant identifier 136 may include one or more attributes and/or parameters related to the merchant, such as business and banking information. In various embodiments, user 102 may conduct transactions (e.g., searching, selection, monitoring, purchasing, and/or providing payment for items) with the merchant device 130 via the service provider server 180 over the networks 160 and 170.

The mobile network operator server 140, in one embodiment, may be maintained by a mobile carrier, such as Verizon®, AT&T®, Vodafone®, Airtel, Aircel, etc. The network operator server 140 receives USSD messages from mobile device 120 via network 160, processes the USSD messages, and forwards them to the service provider server 180 via network 170. In various embodiments, the network operator server 140 includes mobile device account information 142, such as the mobile number of user 102, phone payment history (late or missed payments, account closures, account collection, etc.), services and features used by mobile device 120, usage data, data plans, etc.

The service provider server 180, in one embodiment, may be maintained by a transaction processing entity, which may provide processing for financial transactions and/or information transactions between the user 102 and merchant device 130. As such, the service provider server 180 includes a service application 182, which may be adapted to interact with the mobile device 120 over the networks 160 and 170 to facilitate payment. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing module 184 to process purchases and/or payments for financial transactions between the user 102 and a merchant. In one implementation, the payment processing module 184 assists with resolving financial transactions through validation, delivery, and settlement. As such, the service application 182 in conjunction with the payment processing module 184 settles indebtedness between the user 102 and a merchant, wherein accounts may be directly and/or automatically debited and/or credited of monetary funds in a manner as accepted by the banking industry.

The service provider server 180, in one embodiment, may be configured to maintain one or more user accounts and merchant accounts in an account database 192, each of which may include account information 194 associated with one or more individual users (e.g., user 102). For example, account information 194 may include private financial information of user 102, such as one or more account numbers, passwords, credit card information, banking information, or other types of financial information, which may be used to facilitate financial transactions between user 102 and a merchant. In various aspects, the methods and systems described herein may be modified to accommodate users that may or may not be associated with at least one existing user account.

In one implementation, the user 102 may have identity attributes stored with the service provider server 180, and user 102 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

The service provider server 180 also includes credit score application 186. The application 186 may compute, obtain, and/or evaluate credit scores of the user 102. A person's credit score is a numerical expression based on a statistical analysis of a person's credit files to represent the creditworthiness of that person. Debt level is one of the factors influencing a person's credit score. Debt level may be reflected in terms of credit utilization, which is the amount of debt a person owes in comparison to the person's credit limits. If the credit utilization becomes too high—the amount of debt approaches the credit limits—the person's credit score begins to drop.

In one embodiment, the credit score application 186 contacts a third-party credit system (e.g., Experian®, TransUnion®, or Equifax®) to obtain the credit score of the user 102, and establishes a maximum credit amount based on this credit score. Credit scores may be calculated using different methods. The most well-known and widely used type of credit score is FICO developed by Fair Isaac Corporation. FICO credit scores ranges between 300 and 850. A lower credit score indicates a greater risk that the borrower may default on his or her financial obligations to the lender. A higher credit score means there is less risk that the borrower will default.

In other embodiments, the credit score application 186 queries the mobile network operator server 140 for mobile device account information 142 and/or accesses service provider account information 194 of the user 102. The credit score application 186 can take the mobile device account information 142 and/or account information 194 and compute a credit score.

The credit score can then be used as a basis for either approving or declining a user in a payment transaction. A low risk user has a credit score that indicates a low level risk, and the maximum credit amount assigned can be high. A moderate risk user has a credit score that indicates moderate fraud risk, and the maximum credit assigned can be moderate to high. A high risk user has a credit score that includes a high fraud risk, and the maximum credit assigned can be low.

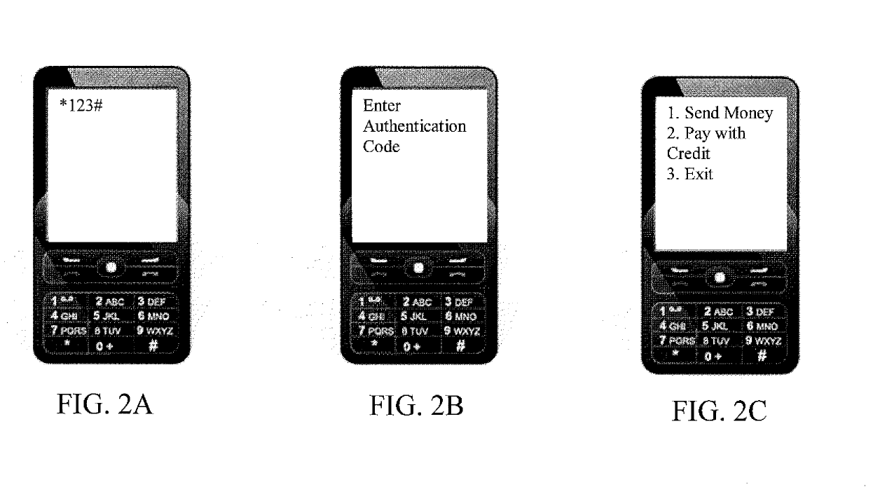

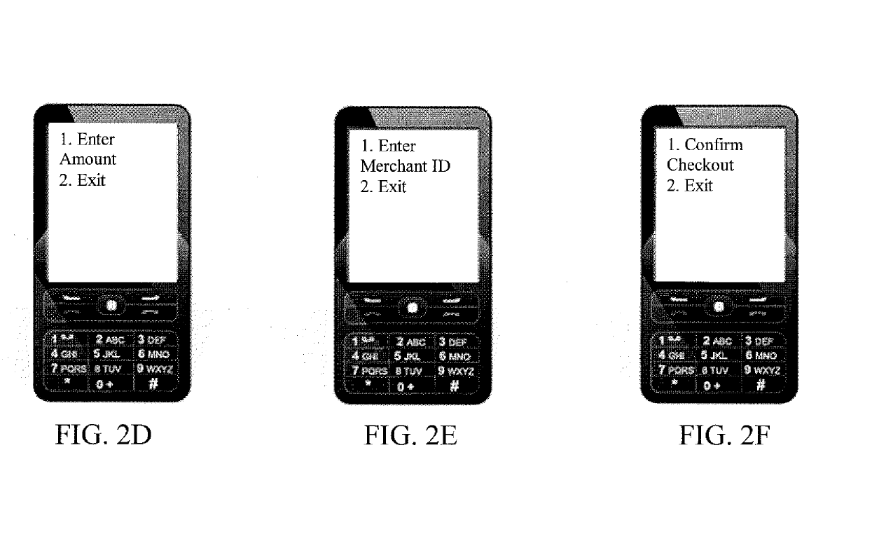

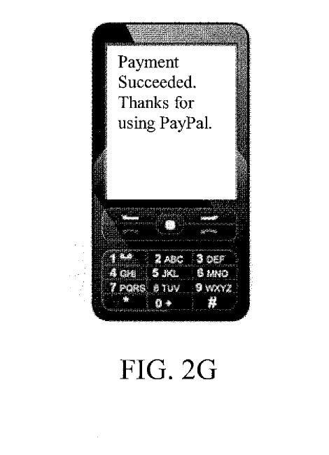

Turning now to FIGS. 2A-2G, illustrated is a sequence of USSD messages displayed to user 102 during a USSD session. At FIG. 2A, user 102 initiates a communication from mobile device 120 by entering the short code “*123#.” The communication request is received at the mobile network operator server 140, which can respond with a request for information that authenticates the mobile device 120 and/or the user 102. As seen in FIG. 2B, the request is displayed on a display screen of the mobile device 120. The authentication code or PIN can be entered using a keypad of the mobile device 120. The authentication code or PIN is then forwarded to service provider server 180 to authenticate the user 102 and determine if the mobile device 120 is authorized to use the mobile credit service. If the mobile device 120 is authorized to use the service, the network operator server 140 can request various types of information that relate to processing a payment, credit, or other transaction.

As seen in FIG. 2C, such requests can be presented in the form of a menu that can be displayed on the mobile device 120. The type of transaction (e.g., sending money, paying with credit, requesting a refund, etc.) can be selected. FIG. 2D illustrates the screen after the user 102 has selected option 2, “Pay with Credit.” The network operator server 140 can prompt for further information, such as the amount of the transaction, a credit card number, etc.

Once the necessary data is collected, the network operator server 140 communicates the information to the service provider server 180. The service provider server 180 obtains and evaluates a credit score associated with the user 102 to determine whether or not to issue credit to the user 102. If the credit score is acceptable, a confirmation is sent to the network operator server 140 to proceed with the transaction. The network operator server 140 requests a merchant ID from the user 102 in FIG. 2E.

The merchant ID is routed to service provider server 180, which identifies the merchant associated with the merchant ID. Before payment is made to the merchant, the user 102 is asked to confirm the transaction in FIG. 2F. Once the transaction is confirmed, a notification (such as that shown in FIG. 2G) is sent to the mobile device 120.

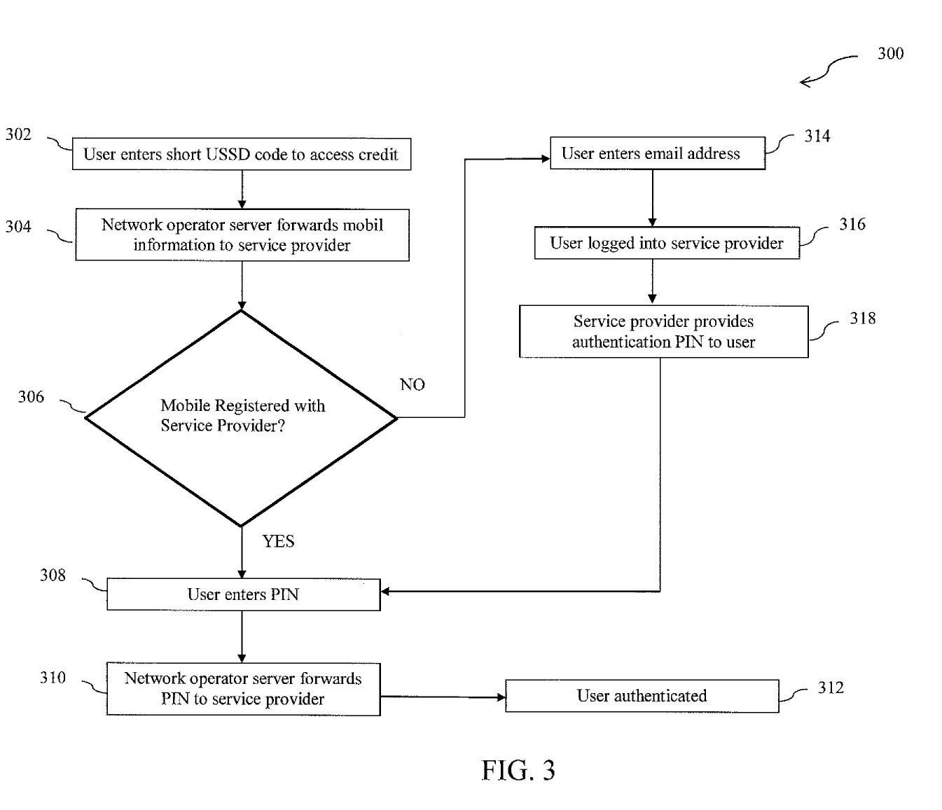

Referring now to FIG. 3, a flowchart of a method 300 for authenticating a user is illustrated according to an embodiment of the present disclosure. In an embodiment, at step 302, user 102 enters a short USSD code to access credit and initiate a communication with network operator server 140. The number or short code can automatically invoke a mobile credit service associated with the service provider server 180. The mobile number or other identification associated with the mobile device 120 is also communicated. At step 304, the network operator server 140 forwards the user's mobile information (e.g., mobile number, mobile ID, etc.) to the service provider server 180. The service provider determines if the user 102 has registered the mobile device 120 with the service provider in step 306. Such determination can be made based on various criteria such as whether the user 102 has access to the mobile credit service. The access to the service may be based on whether the user 102 has signed up for such service or accepted terms and conditions related to such service.

If the mobile device 120 has been registered, the method continues to step 308, where the user enters a PIN (or other authentication information) into the mobile device 120. The authentication information is forwarded to the service provider server 180 by the network operator server 140 in step 310 to authenticate the user 102. In step 312, the user 102 is authenticated.

If the mobile device 120 has not been registered, the user 102 is prompted to enter an email address, and at step 314, the user 102 enters the address. Once the user 102 is logged into or on-boarded to the service provider site in step 316, the service provider provides an authentication PIN to the user 102. The user 102 enters the PIN and is authenticated to the server 180.

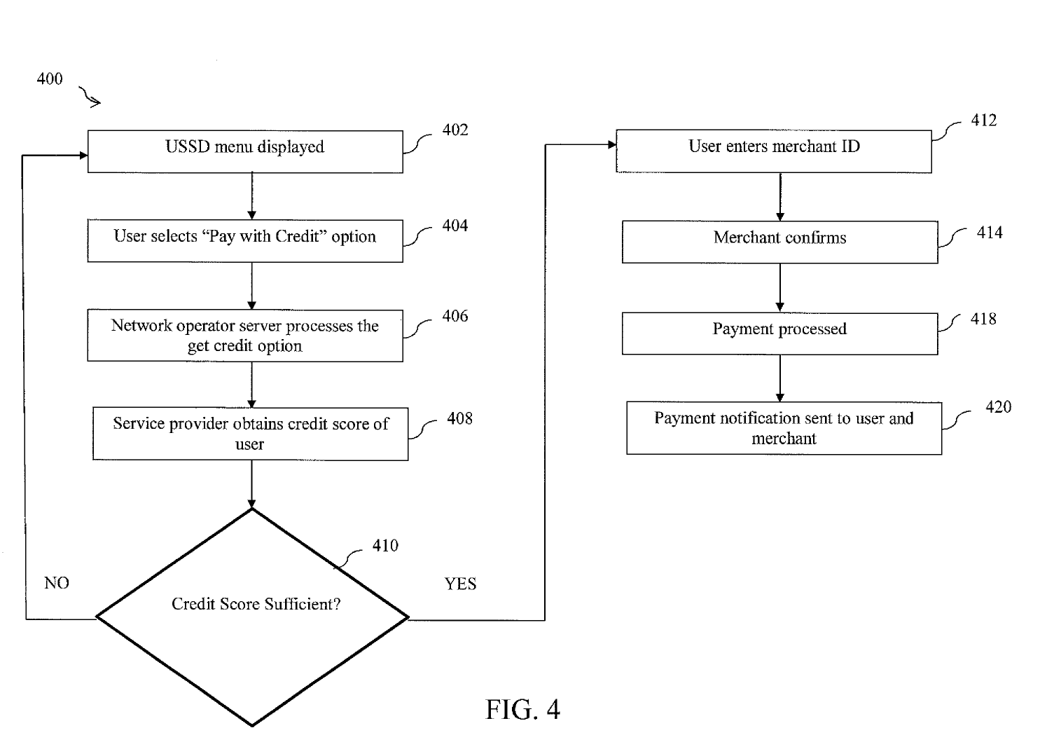

Referring now to FIG. 4, a flowchart of a method 400 for providing credit through USSD is illustrated according to an embodiment of the present disclosure. After the mobile device 120 and the user 102 have been authenticated with the server 180, menu selections and/or prompts are presented to the user 102. Such prompts and/or menu selections can be USSD menu prompts that should be answered for each input of information necessary to verify the payment information. The prompts and/or menu selections can be displayed on a display screen, communicated audibly, or through other communication means. Such menu selections can be presented to the user 102 based on prompts received from the service provider server 180. At step 402, a USSD menu is displayed to the user 102.

The menu selections can include a type of transaction (e.g., purchase, refund, void transaction, view transaction, pay with credit, etc.) and/or amount of the transaction. Other menu selections and/or prompts can include other payment verification information, such as the user's zip code information, telephone number, etc. The prompts and/or menu selections can be presented to the user 102 individually or at substantially the same time as a response to a previous menu selection and/or prompt is answered. The method 400 can present a next prompt and/or menu selection to the user 102 if additional information is necessary. It is to be understood that this act can be self-repeating such that any number of menu selections and/or prompts can be presented for information. Moreover, it is to be appreciated that automated and/or dynamic requests for information can be employed in connection with alternate aspects if a previous entry is incorrect or does not match database information. For example, the system can be configured to automatically request additional and/or alternative information dynamically in accordance with an incorrect or inconclusive response to a previous prompt and/or selection. At step 404, the user 102 selects the “Pay with Credit” option.

At step 406, the network operator server 140 processes the get credit option. For example, the server 140 forwards the information received from the mobile device 120 to service provider server 180, returns messages from the service provider server 180 to the mobile device 120, and acts to facilitate the issuance of credit to the user 102 by displaying USSD messages and receiving responses.

At step 408, the service provider server 180 obtains a credit score of the user 102. As discussed above, in one embodiment, the credit score can be obtained from a third-party credit system. Alternatively, the credit score can be obtained by utilizing mobile usage statistics and/or service provider statistics to compute a credit score for the user. For example, payment history, amount of payments, mobile phone usage, length of contract, financial accounts, etc. can be used to calculate a credit score. These items may be entered into a formula that outputs a credit score.

At step 410, it is determined whether or not the credit score is sufficient. In some embodiments, a determination of whether the credit score exceeds or crosses a certain threshold value is made. The threshold may be associated with the level of certainty that the user 102 is or is not credit worthy. If the credit score exceeds the threshold value, the user 102 may be determined to be credit worthy. It the credit score fails to exceed the threshold value, the user 102 may be denied credit.

At step 412, the credit score is found to be sufficient, so the network operator server 140 continues with the transaction by prompting user 102 for the merchant ID, which the user 102 enters into the mobile device 120. The merchant ID can be obtained from the merchant, and is associated with a merchant account maintained by service provider server 180.

At step 414, the merchant confirms the payment amount, and at step 418, the payment is processed by the service provider server 180. The service provider issues credit to the user and the issued credit is applied to the purchase. The funds for the purchase are then transferred to a merchant account. At step 420, a payment notification is sent to both the merchant and the user 102 to serve as proof or receipt of payment. In one embodiment, the notification is sent as a short message service (SMS) message.

In various embodiments, instead of the user 102 manually entering responses into the mobile device 120, the user 102 can provide an audible answer. In one embodiment, an interactive voice response (NR) system is coupled to and used by the service provider server 180 to provide credit to the user 102. The IVR system presents audible questions to the user 102 and prompts the user 102 to respond. The user 102 responds by verbalizing his or her answer and, in some embodiments, pressing a number or symbol on a keypad. Thus, the user 102 is taken through the USSD menu by listening to a series of voice prompts and verbally providing answers.

For example, referring back to FIGS. 2A-2G, instead of text being displayed on the mobile device 120, the user 102 hears or speaks the information requested. At FIG. 2A, the user 102 enters the short code “*123.” At FIG. 2B, the user 102 is verbally asked to provide his or her authentication code. Once the user 102 is authenticated, at FIG. 2C, the user 102 listens to the different options available, and answers that he or she wants option 2 “Pay with Credit.” At FIG. 2D, the user 102 is asked to enter the amount of the credit requested, and the user 102 replies by speaking the dollar amount. If the user 102's credit score is acceptable, he or she is then prompted to verbally provide the merchant ID at FIG. 2E. At FIG. 2F, the user 102 is asked to confirm checkout, and the user 102 responds with option 1 “Confirm Checkout.” Finally, at FIG. 2G, the user 102 hears the message that, “Payment succeeded. Thanks for using PayPal.”

The present disclosure describes financial transactions that can be processed through USSD technology without requiring extra hardware or special client software to be installed on a mobile device. The methods and systems described herein provide cost effective ways to make payments in a timely and secure manner without being limited to Internet access. The mobile device becomes an electronic payment instrument that can lead to a substantial reduction in a user's dependency on cards/plastics, checks, and cash, thus strengthening customer security and fraud prevention efforts.

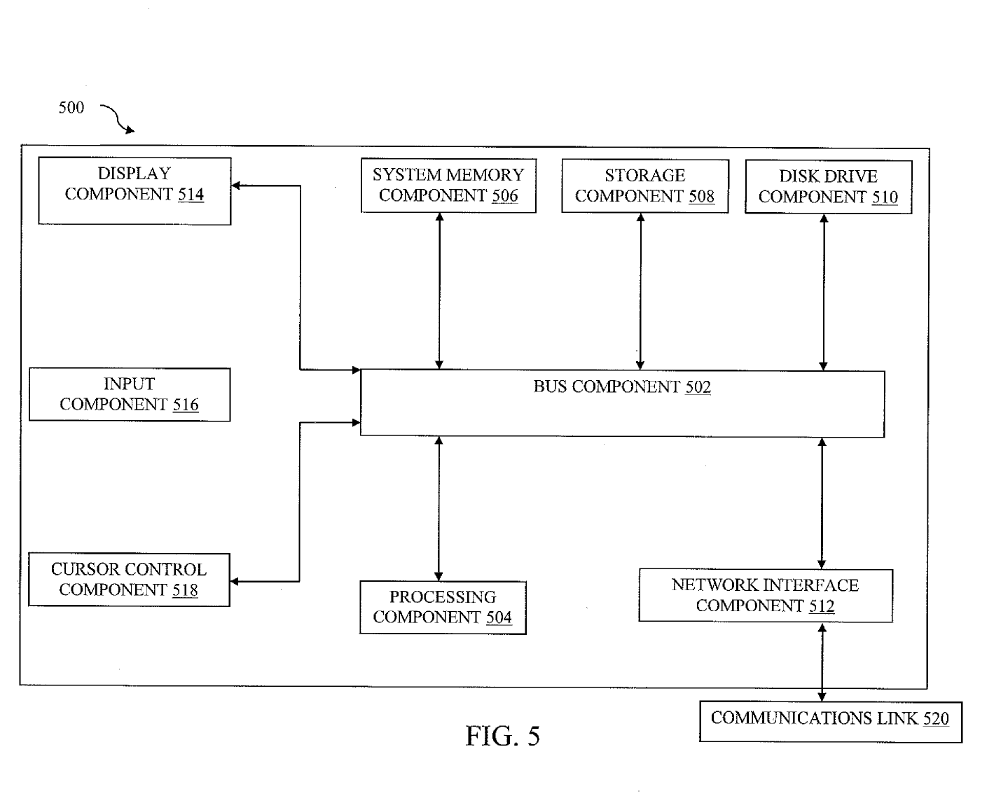

Referring now to FIG. 5, a block diagram of a system 500 is illustrated suitable for implementing embodiments of the present disclosure, including mobile devices 120, merchant device 130, mobile network operator server 140, and service provider server or device 180. System 500, such as part of a cell phone, a tablet, a personal computer and/or a network server, includes a bus 502 or other communication mechanism for communicating information, which interconnects subsystems and components, including one or more of a processing component 504 (e.g., processor, micro-controller, digital signal processor (DSP), etc.), a system memory component 506 (e.g., RAM), a static storage component 508 (e.g., ROM), a network interface component 512, a display component 514 (or alternatively, an interface to an external display), an input component 516 (e.g., keypad or keyboard), and a cursor control component 518 (e.g., a mouse pad).

In accordance with embodiments of the present disclosure, system 500 performs specific operations by processor 504 executing one or more sequences of one or more instructions contained in system memory component 506. Such instructions may be read into system memory component 506 from another computer readable medium, such as static storage component 508. These may include instructions to process financial transactions, make payments, issue credit, calculate a credit score, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 504 for execution. Such a medium may take many forms, including but not limited to, non-volatile media, volatile media, and transmission media. In various implementations, volatile media includes dynamic memory, such as system memory component 506, and transmission media includes coaxial cables, copper wire, and fiber optics, including wires that comprise bus 502. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 500. In various other embodiments, a plurality of systems 500 coupled by communication link 520 (e.g., networks 160 and 170 of FIG. 1, LAN, WLAN, PTSN, or various other wired or wireless networks) may perform instruction sequences to practice the disclosure in coordination with one another. Computer system 500 may transmit and receive messages, data, information and instructions, including one or more programs (i.e., application code) through communication link 420 and communication interface 512. Received program code may be executed by processor 504 as received and/or stored in disk drive component 510 or some other non-volatile storage component for execution.

In view of the present disclosure, it will be appreciated that various methods and systems have been described according to one or more embodiments for providing credit through USSD technology.

Although various components and steps have been described herein as being associated with mobile device 120, merchant device 130, mobile network operator server 140, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user and merchant financial account information; and
one or more processors in communication with the memory device and operable to:
receive authentication information associated with a mobile device of a user, wherein the authentication information is transmitted as a first unstructured supplementary service data (USSD) message to a network operator and forwarded to the service provider;
selectively request payment information contained in a second USSD message from the mobile device via the network operator;
receive the requested payment information contained in a third USSD message from the mobile device via the network operator;
evaluate a credit score of the user;
issue credit to the user when the credit score exceeds a predefined threshold value; and
pay a merchant associated with the payment information using the issued credit.

2. The system of claim 1, wherein the one or more processors is further operable to evaluate the credit score by analyzing mobile usage statistics and/or service provider user statistics.

3. The system of claim 2, wherein the one or more processors is further operable to compute the credit score based on the mobile usage statistics and/or the service provider user statistics.

4. The system of claim 1, wherein the requested payment information comprises payment amount, merchant ID, or a combination thereof.

5. The system of claim 1, wherein the one or more processors is further operable to process the payment request by transferring funds to a merchant account maintained by the service provider.

6. The system of claim 1, wherein the authentication information comprises a personal identification number.

7. The system of claim 1, wherein the one or more processors is further operable to receive and transmit audible information.

8. A method for providing credit through USSD technology, comprising:
receiving, by one or more hardware processors of a service provider, authentication information associated with a mobile device of a user, wherein the authentication information is transmitted as a first unstructured supplementary service data (USSD) message to a network operator and forwarded to the service provider;
selectively requesting payment information contained in a second USSD message from the mobile device via the network operator;
receiving the requested payment information contained in a third USSD message from the mobile device via the network operator;
evaluating a credit score of the user;
issuing credit to the user when the credit score exceeds a predefined threshold value; and
paying a merchant associated with the payment information using the issued credit.

9. The method of claim 8, wherein evaluating the credit score of the user comprises analyzing mobile usage statistics and/or service provider user statistics.

10. The method of claim 9, further comprising computing the credit score based on the mobile usage statistics and/or the service provider user statistics.

11. The method of claim 8, wherein the requested payment information comprises payment amount, merchant ID, or a combination thereof.

12. The method of claim 8, wherein processing the payment request comprises transferring funds to a merchant account maintained by the service provider.

13. The method of claim 8, wherein the authentication information comprises a personal identification number.

14. The method of claim 8, wherein receiving the authentication information, selectively requesting payment information, and/or receiving the requested payment information is through an interactive voice response session.

15. A non-transitory machine-readable medium comprising a plurality of machine-readable instructions which, when executed by one or more processors, are adapted to cause the one or more processors to perform a method comprising:
receive authentication information associated with a mobile device of a user, wherein the authentication information is transmitted as a first unstructured supplementary service data (USSD) message to a network operator and forwarded to the service provider;
selectively request payment information contained in a second USSD message from the mobile device via the network operator;
receive the requested payment information contained in a third USSD message from the mobile device via the network operator;
evaluate a credit score of the user; issue credit to the user if the credit score exceeds a predefined threshold value; and
pay a merchant associated with the payment information using the issued credit.

16. The non-transitory machine-readable medium of claim 15, wherein evaluating the credit score of the user comprises analyzing mobile usage statistics and/or service provider user statistics.

17. The non-transitory machine-readable medium of claim 16, wherein the method further comprises computing the credit score based on the mobile usage statistics and/or the service provider user statistics.

18. The non-transitory machine-readable medium of claim 15, wherein the requested payment information comprises payment amount, merchant ID, or a combination thereof.

19. The non-transitory machine-readable medium of claim 15, wherein processing the payment request comprises transferring funds to a merchant account maintained by the service provider.

20. The non-transitory machine-readable medium of claim 15, wherein receiving the authentication information, selectively requesting payment information, and/or receiving the requested payment information is through an interactive voice response session.
